(19) United States
(12) Patent Application Publication
(10) Pub. No.: US 2017/0257863 A1
(43) Pub. Date: Sep. 7, 2017

(54) METHOD FOR OPERATING STATION IN WIRELESS LAN

(71) Applicant: Electronics and Telecommunications Research Institute, Daejeon (KR)

(72) Inventors: Gwang Zeen KO, Daejeon (KR); Hyun Duk KANG, Gwangju (KR); Igor KIM, Daejeon (KR); Myung Sun SONG, Daejeon (KR)

(73) Assignee: Electronics and Telecommunications Research Institute, Daejeon (KR)

(21) Appl. No.: 15/479,824

(22) PCT Filed: Nov. 24, 2015
(86) PCT No.: PCT/KR2015/012676

§ 371 Date: Apr. 5, 2017

(30) Foreign Application Priority Data
Nov. 27, 2014 (KR) 10-2014-0167559

(51) Int. Cl. H04W 72/04; H04W 24/02

(52) U.S. Cl. CPC H04W 72/0446; H04W 72/0453; H04W 24/02; H04W 84/12

(57) ABSTRACT

A method for operating a station in a wireless LAN is disclosed. An OFDMA-based communication method comprises the steps of: receiving, from an access point, a first frame including time resource information and frequency resource information indicating a resource occupied for an OFDMA-based communication; and receiving, from the access point, a data frame through the resource indicated by the time resource information and frequency resource information. Therefore, performance of the wireless LAN system can be improved.

### TECHNICAL FIELD

The present disclosure relates to a wireless local area network (WLAN) technology, and more particularly to an operation method of a station for multi-user transmission.

### BACKGROUND ART

Various wireless communication technologies are being developed along with the development of information communication technology. Among them, wireless local area network (WLAN) technology is technology to allow a mobile terminal such as a personal digital assistant (PDA), a laptop computer, a portable multimedia player, a smart phone, a tablet personal computer (PC), etc. to connect to the Internet wirelessly in homes and businesses, or a specific service provision area based on radio frequency technology.

A standard of the WLAN technology is being developed as an Institute of Electrical and Electronics Engineers (IEEE) 802.11 standard. The WLAN technology according to an IEEE 802.11a standard operates based on an orthogonal frequency division multiplexing (OFDM) method, and provides a transmission speed of maximum 54 Mbps in a 5 band GHz. The WLAN technology according to an IEEE 802.11b standard operates based on a direct sequence spread spectrum (DSSS) method, and provides a transmission speed of maximum 11 Mbps in a 2.4 GHz band. The WLAN technology according to an IEEE 802.11g standard operates based on the OFDM method or the DSSS method, and provides a transmission speed of maximum 54 Mbps in the 2.4 GHz band.

The WLAN technology according to an IEEE 802.11n standard operates in the 2.4 GHz and 5 GHz bands based on the OFDM method, and when using a multiple input multiple output-OFDM (MIMO-OFDM) method, provides a transmission speed of maximum 300 Mbps with respect to four spatial streams. The WLAN technology according to the IEEE 802.11a standard supports a maximum channel bandwidth of 40 MHz, and in this case, provides a transmission speed of maximum 600 Mbps.

As the spread of the WLAN is ongoing and various applications using the same are developed, there is an increasing need for a new WLAN to support a greater throughput than a data processing speed which the IEEE 802.11n standard supports. Very high throughput (VHT) WLAN technology is one of the IEEE 802.11 technologies which are being offered in order to support a data processing speed which is equal to or more than 1 Gbps. Among them, an IEEE 802.11ac is being developed as a standard for providing the VHT at a band which is equal to or less than 5 GHz, and an IEEE 802.11ad is being developed as a standard for providing the VHT at a 60 GHz band.

Meanwhile, in the communication system based on such the WLAN technology, a multi-used (MU) transmission may be performed. The MU transmission may include uplink and downlink transmission based on orthogonal frequency division multiple access (OFDMA), and uplink and downlink transmission based on multi-user multiple input and multiple output (MU-MIMO) technologies. When a plurality of stations participate in the MU transmission, a method for notifying information on channels occupied by the MU transmission is demanded.

### DISCLOSURE

### Technical Problem

In order to resolve the above-described problem, the present invention is to provide an operation method of a station for communications based on uplink OFDMA.

Also, in order to resolve the above-described problem, the present invention is provided an operation method of a station for communications based on downlink OFDMA.

### Technical Solution

An OFDMA based communication method to achieve the above-described objective, performed by a first station, may comprise receiving a first frame including time resource information and frequency resource information indicating a resource occupied for the OFDMA based communications from an access point (AP); and receiving a data frame from the AP through the resource indicated by the time resource information and the frequency resource information.

Here, the first frame may be a Request-To-Send (RTS) frame.

Here, the first frame may include an indicator which indicates that the OFDMA based communications are performed.

Here, the first frame may include identifiers for a plurality of stations participating in the OFDMA based communications.

Here, the first frame may include information on a time resource occupied by a data unit included in a data frame, which each of the plurality of stations participating in the OFDMA based communications receives.

Here, the first frame may be received through a whole bandwidth of a frequency resource indicated by the frequency resource information.

Here, the frequency resource information may be included in a payload of the first frame.

Here, a longest time resource among time resources occupied by the plurality of stations participating in the OFDMA based communications may be configured as a time resource indicated by the time resource information.

Here, the method may further comprise, in response to the first frame, transmitting a second frame including the time resource information and the frequency resource information to the AP.

Also, the second frame may be a Clear-To-Send (CTS) frame.

An OFDMA based communication method to achieve the above-described objective, performed by a first station, may comprise receiving a first frame including time resource information and frequency resource information indicating a resource occupied for the OFDMA communications from an access point (AP); and transmitting a data frame to the AP through the resource indicated by the time resource information and the frequency resource information.

Here, the first frame may include an indicator which indicates that the OFDMA based communications are performed.

Here, the first frame may include identifiers for a plurality of stations participating in the OFDMA based communications.

Here, the first frame may include information on a time resource occupied by a data unit included in a data frame, which each of the plurality of stations participating in the OFDMA based communications receives.

Here, a longest time resource among time resources occupied by the plurality of stations participating in the OFDMA based communications may be configured as a time resource indicated by the time resource information.

Here, the method may further comprise, when the first frame is received, transmitting a second frame including the time resource information and the frequency resource information; and receiving, as a response to the second frame, a third frame including the time resource information and the frequency resource information from the AP.

Also, the second frame may be a Request-To-Send (RTS) frame.

Also, the second frame may be transmitted through a whole bandwidth of a frequency resource indicated by the frequency resource information.

Also, the frequency resource information may be included in a payload of the second frame.

Also, the third frame may be a Clear-To-Send (CTS) frame.

### Advantageous Effects

According to exemplary embodiments of the present disclosure, information on a channel used for multi-user transmission (e.g. OFDMA, MU-MIMO, etc.) may be notified. When a station obtains the information on the channel used for multi-user transmission, the station may not use the channel indicated by the information. That is, the station may transmit and receive a frame by using a channel which is not the channel indicated by the information. Meanwhile, a station in accordance with a legacy WLAN standard (e.g. IEEE 802.11a/b/g/n/ac) may obtain the information on the channel used for multi-user transmission, and may not use the channel indicated by the information. Therefore, radio resources can be utilized efficiently, and performance of the W LAN system can also be improved.

### DESCRIPTION OF DRAWINGS

FIG. 1 is a block diagram illustrating a configuration of a station performing methods according to an exemplary embodiment of the present disclosure.

FIG. 2 is a schematic diagram illustrating a configuration of a wireless local area network system that conforms to an IEEE 802.11 according to an exemplary embodiment of the present disclosure.

FIG. 3 is a timing diagram illustrating a method for transmitting and receiving a frame.

FIG. 4 is a conceptual diagram illustrating an example of a WLAN topology.

FIG. 5 is a timing diagram illustrating an OFDMA based downlink transmission method according to an exemplary embodiment of the present disclosure.

FIG. 6 is a timing diagram illustrating an OFDMA based downlink transmission method according to another exemplary embodiment of the present disclosure.

FIG. 7 is a timing diagram illustrating an OFDMA based uplink transmission method according to an exemplary embodiment of the present disclosure.

FIG. 8 is a timing diagram illustrating an OFDMA based uplink transmission method according to another exemplary embodiment of the present disclosure.

### MODE FOR INVENTION

While the invention is susceptible to various modifications and alternative forms, specific embodiments thereof are shown by way of examples in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the inventive concept will be described in detail with reference to the accompanying drawings. In order to facilitate a throughout understanding in the following description, like numbers refer to like elements in the drawings, and duplicated descriptions will be omitted with respect to the like elements.

Throughout the specification, a station (STA) may denote an arbitrary function entity including a medium access control (MAC) which follows regulations of an Institute of Electrical and Electronics Engineers (IEEE) 802.11 standard and a physical layer interface with respect to a wireless medium. The station may be classified as a station (STA) which is an access point (AP) and a station (STA) which is a non-access point (non-AP). The station (STA) which is the access point (AP) may be simply referred to as an access point (AP), and the station (STA) which is the non-access point (non-AP) may be simply referred to as a terminal.

The STA may include a processor and a transceiver, and may further include a user interface and a display device, etc. The processor may denote a unit designed to generate a frame to be transmitted through a wireless network or process a frame received through the wireless network, and may perform various functions for controlling the STA. The transceiver may be functionally connected with a processor, and denotes a unit designed in order to transmit and receive a frame through the wireless network for the STA.

The AP may be referred to as an centralized controller, a base station (BS), a radio access station, a node B, an evolved node B, a relay, a mobile multi-hop relay-BS, a base transceiver system (BTS), or a site controller, etc., and may include a part or all of functions thereof.

The terminal (that is, the non-AP) may be referred to as a wireless transmitting/receiving unit (WTRU), user equipment (UE), a user terminal (UT), an access terminal (AT), a mobile station (MS), a mobile terminal, a subscriber unit, a subscriber station (SS), a wireless device, or a mobile subscriber unit, etc., and may include a part or all of functions thereof.

Here, the terminal may be a desktop computer, a laptop computer, a tablet PC, a wireless phone, a mobile phone, a smart phone, a smart watch, a smart glass, an e-book reader, a portable multimedia player (PMP), a portable game player, a navigation device, a digital camera, a digital multimedia broadcasting (DMB) player, a digital audio recorder, a digital audio player, a digital picture recorder, a digital picture player, a digital video recorder, a digital video player, etc. which can perform communication.

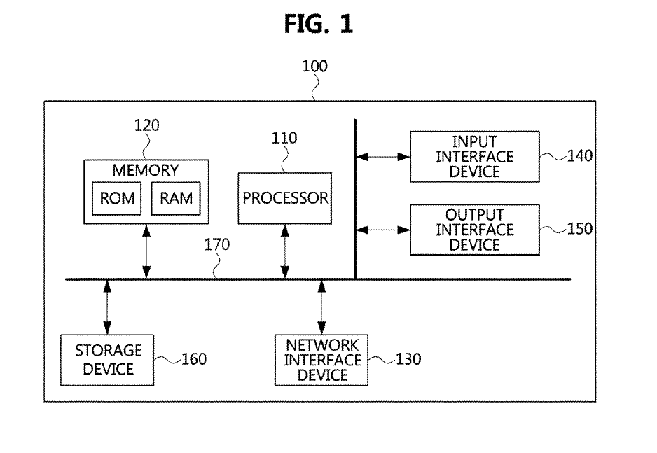

FIG. 1 is a block diagram illustrating a configuration of a station performing methods according to an exemplary embodiment of the present disclosure.

Referring to FIG. 1, a station (STA) 100 may include at least one processor 110, a memory 120, and a network interface device 130 which is connected to a network and performs communication. Further, the STA 100 may further include an input interface device 140, an output interface device 150, and a storage device 160, etc. Each component included in the station 100 may be connected through a bus 170, and mutually perform communication.

The processor 110 may execute a program command stored in the memory 120 and/or the storage device 160. The processor 110 may mean a central processing unit (CPU), a graphic processing unit (GPU), or an exclusive processor in which methods according to the inventive concept are performed. The memory 120 and the storage device 160 may be configured as a volatile storage medium and/or a non-volatile storage medium. For example, the memory 120 may be configured as a read only memory (ROM) and/or a random access memory (RAM).

Exemplary embodiments of the inventive concept may be applied to a WLAN system according to an IEEE 802.11 standard, and may also be applied to another communication system as well as the WLAN system according to the IEEE 802.11 standard.

For example, exemplary embodiments of the inventive concept may be applied to a mobile Internet such as a wireless personal area network (WPAN), a wireless body area network (WBAN), a wireless broadband Internet (WiBro), or world interoperability for microwave access (WiMax), a second generation (2G) mobile communication network such as global system for mobile communications (GSM) or code division multiple access (CDMA), a third generation (3G) mobile communication network such as wideband code division multiple access (WCDMA) or CDMA2000, a 3.5 generation (3.5G) mobile communication network such as high speed downlink packet access (HSDPA) or high speed uplink packet access (HSUPA), a fourth generation (4G) mobile communication network such as long term evolution (LTE) or LTE-Advanced, and a fifth generation (5G) mobile communication network, etc.

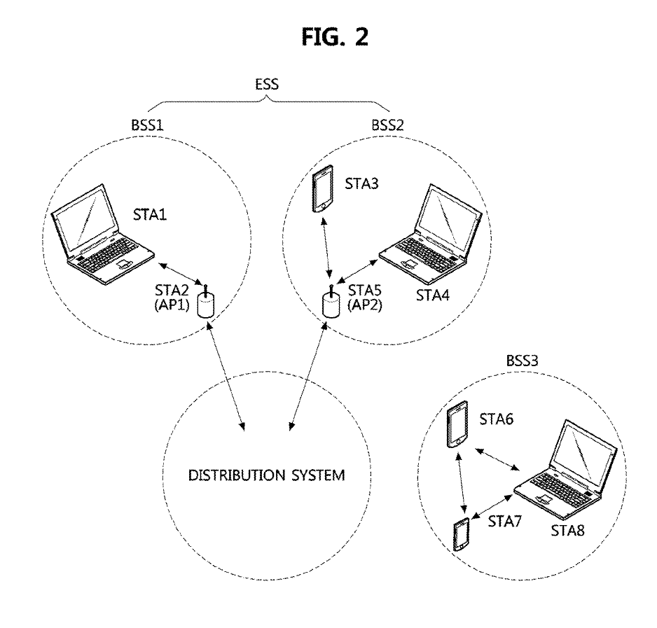

FIG. 2 is a schematic diagram illustrating a configuration of a wireless local area network system that conforms to an IEEE 802.11 according to an exemplary embodiment of the present disclosure.

Referring to FIG. 2, a WLAN system according to an IEEE 802.11 may include at least one basic service set (BSS). The BSS may denote a set of stations STA1, STA2 (AP1), STA3, STA4, STA5 (AP2), STA6, STA7, and STA8 capable of communicating with each other by performing successful synchronization, and may not denote a specific area.

The BSS may be classified as an infrastructure BSS and an independent BSS (IBSS). Here, BSS1 and BSS2 may be the infrastructure BSSs, and BSS3 may be the IBSS.

The BSS1 may include a first terminal STA1, a first access point STA2 (AP1) providing a distribution service, and a distribution system DS connecting a plurality of access points STA2 (AP1) and STA5 (AP2). In the BSS1, the first access point STA2 (AP1) may manage the first terminal STA1.

The BSS2 may include a third terminal STA3, a fourth terminal STA4, a second access point STA5 (AP2) providing a distribution service, and a distribution system connecting the plurality of access points STA2 (AP1) and STA5 (AP2). In the BSS2, the second access point STA5 (AP2) may manage the third terminal STA3 and the fourth terminal STA4.

The BSS3 may denote the IBSS operating in an ad-hoc mode. There is no access point which is a centralized management entity in the BSS3. That is, in the BSS3, the terminals STA6, STA7, and STA8 may be managed in a distributed manner. In the BSS3, each terminal STA6, STA7, and STA8 may denote a mobile terminal, and since the terminals STA6, STA7, and STA8 are not allowed to connect to the distribution system DS, a self-contained network may be constructed.

The access points STA2 (AP1) and STA5 (AP2) may provide access to the distribution system DS through a wireless medium for the terminals STA1, and STA3 and STA4, connected to the access points themselves. Communication between the terminals STA1, STA3, and STA4 in the BSS1 or BSS2 may be generally performed through the access points STA2 (AP1) and STA5 (AP2), but direct communication may be performed between the terminals STA1, STA3, and STA4 when a direct link is set.

A plurality of infrastructure BSSs may be connected to each other through the distribution system DS. The plurality of infrastructure BSSs connected through the distribution system DS may be referred to as an extended service set (ESS). The entities STA1, STA2 (AP1), STA3, STA4, and STA5 (AP2) included in the ESS may communicate with each other, and arbitrary terminals STA1, STA3, and STA4 may move from one BSS to another BSS while seamlessly communicating in the same ESS.

The distribution system DS may be a mechanism for one access point to communicate with another access point, and the access point may transmit a frame for terminals connected in the BSS managed by the AP, or transmit a frame for an arbitrary terminal moved to another BSS. Further, the access point may transmit and receive a frame with an external network such as a wired network, etc. The distribution system DS may not be necessarily a network, and there is no limit to the configuration of the distribution system DS when providing a predetermined distribution service prescribed by the IEEE 802.11 standard. For example, the distribution system DS may be a wireless network such as a mesh network, or a physical structure to connect the access points with each other.

Meanwhile, a station operating in an unlicensed band (e.g. an industry science medical (ISM) band) should not interfere with operations of other stations in the unlicensed frequency band. Thus, the station may use a listen before talk (LBT) method to transmit a frame. The stations supporting the LBT method can transmit its own frame when transmissions of other stations are not detected in the unlicensed band. For example, a physical (PHY) layer of the station may determine that a transmission of another station exists when a received signal strength is not less than a predetermined threshold. In this case, the station may determine whether a transmission of another station exists or not again after a lapse of a predetermined time duration. In other cases, the station may determine that transmissions of other stations do not exist in the band. Also, upon receiving a frame, a medium access control (MAC) layer of the station may obtain a duration field included in a MAC header of the frame received through the PHY layer, and determine that a transmission of another station is to be performed during a time indicated by the duration field.

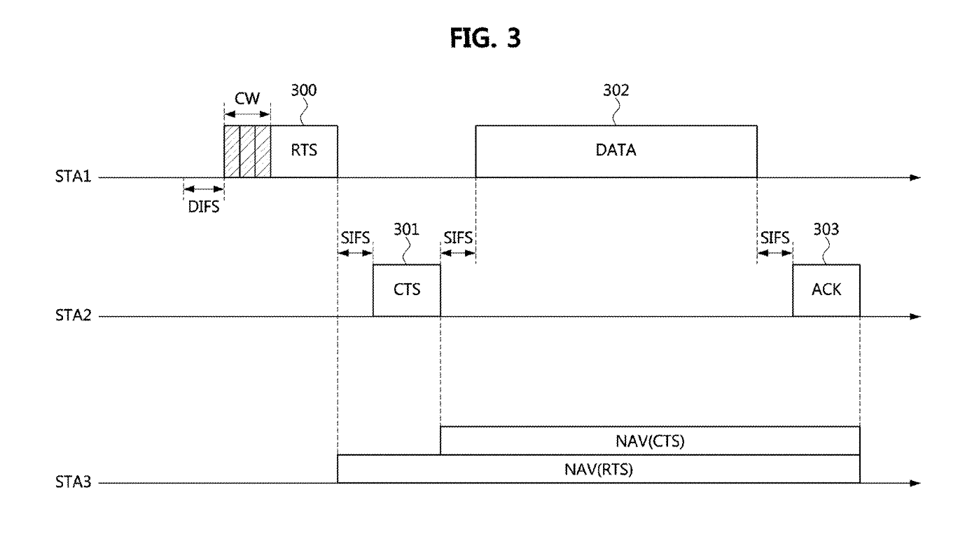

FIG. 3 is a timing diagram illustrating a method for transmitting and receiving a frame.

Referring to FIG. 3, when it is determined that the channel is not in use by other devices during a distributed coordinated function inter frame space (DIFS) (that is, the channel is idle), the STA1 wanting to transmit a data frame 302 may transmit a Request-To-Send (RTS) frame 300 after a lapse of a contention window (CW) according to a random backoff operation. A duration field included in a MAC header of the RTS frame 300 may indicate a time required for transmitting the data frame 302. For example, the duration field included in the MAC header of the RTS frame 300 may indicate a time corresponding to a duration of SIFS+Clear-To-Send (CTS) frame 301+SIFS+data frame 302+SIFS+acknowledgement (ACK) frame 303.

The STA2 may receive the RTS frame 300, and identify the duration field included in the MAC header of the RTS frame 300. The STA2 may generate a Clear-to-Send (CTS) frame 301 which is a response to the RTS frame 300. A time indicated by a duration field included in a MAC header of the CTS frame 301 may be configured based on the time indicated by the duration field included in the MAC header of the RTS frame 300. For example, the duration field included in the MAC header of the CTS frame 301 may indicate a duration of SIFS+data frame 302+SIFS+ACK frame 303.

The STA2 may transmit the CTS frame 301 after a SIFS elapses from a time when the RTS frame 300 has been completely received. Also, the STA1 may receive the CTS frame 301, and transmit the data frame 302 to the STA2 after a SIFS elapses from a time when the CTS frame 301 has been received. Also, upon successfully receiving the data frame 302, the STA2 may transmit an ACK frame 303 to the STA1 after a SIFS elapses from a time when the data frame 302 has been received. When the ACK frame 303 is successfully received, the STA1 may determine that the data frame 302 has been successfully received at the STA2.

Meanwhile, the STA3 also may obtain the RTS frame 300, and determine that the frame transmission of the STA1 is performed during a time duration indicated by the duration field included in the MAC header of the RTS frame 300. According to the information indicated by the duration field, the STA3 may not attempt a channel access during the time duration indicated by the duration field of the MAC header of the RTS frame 300. That is, the STA3 may configure a network allocation vector (NAV) timer corresponding to the time duration indicated by the duration field included in the MAC header of the RTS frame 300. Alternatively, the STA3 may obtain the CTS frame 301, and determine that the frame transmission of the STA2 is performed during a time duration indicated by the duration field of the MAC header of the CTS frame 301. According to the information indicated by the duration field, the STA3 may not attempt a channel access during the time duration indicated by the duration field of the MAC header of the CTS frame 301. That is, the STA3 may configure a NAV timer corresponding to the time duration indicated by the duration field included in the MAC header of the CTS frame 301.

In such the frame transmission and reception method, each of the stations STA1, STA2, and STA3 using the same frequency band may determine whether the channel is occupied or not by using only temporal information. However, when OFDMA based communications are performed, since the respective stations STA1, STA2, and STA3 may operate on different frequency bands, it may be difficult to determine whether the channel is occupied or not by using only temporal information.

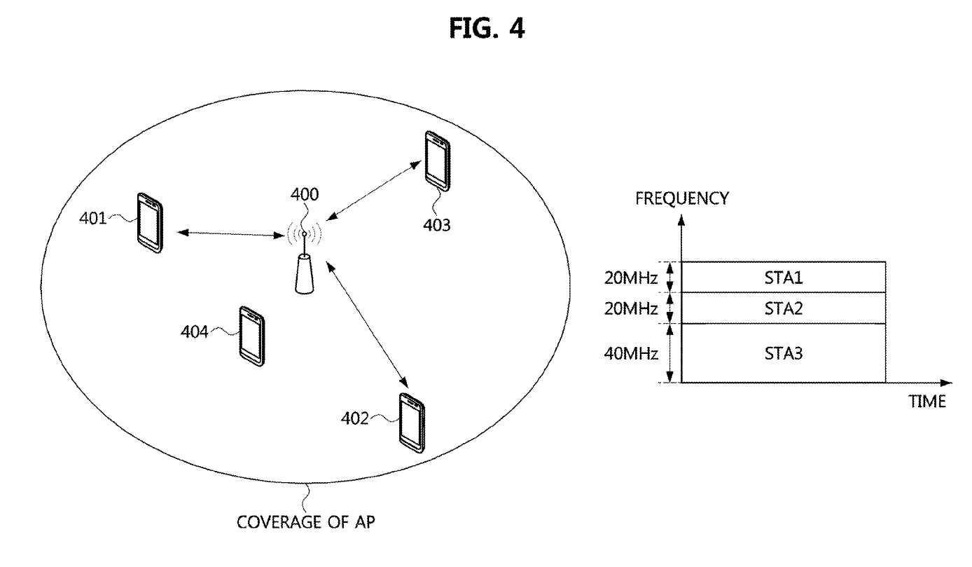

FIG. 4 is a conceptual diagram illustrating an example of a WLAN topology.

Referring to FIG. 4, an AP 400 and a plurality of STAs 401, 402, 403, and 404 may constitute a BSS. Each of the plurality of STAs may belong to coverage of the AP 400. The AP 400 and each of the plurality of STAs may participate in communications based on OFDMA. That is, the AP 400 may perform downlink transmissions for the STAs 401, 402, and 403 based on OFDMA. Also, the STAs 401, 402, and 403 may perform uplink transmissions to the AP 400 based on OFDMA.

For example, in a case that the OFDMA based communications are performed using a frequency band having a bandwidth of 80 MHz, the first STA 401 may use a first frequency band of 20 MHz among the 80 MHz frequency band to perform the OFDMA based communications, and the second STA 402 may use a second frequency band of 20 MHz among the 80 MHz frequency band, which is contiguous to the first frequency band, to perform the OFDMA based communications. Also, the third STA 403 may use a third frequency band of 40 MHz among the 80 MHz frequency band, which is contiguous to the second frequency band, to perform the OFDMA based communications.

For another example, in a case that the OFDMA based communications are performed using a frequency band having a bandwidth of 20 MHz, the first STA 401 may use a first frequency band of 5 MHz among the 20 MHz frequency band to perform the OFDMA based communications, and the second STA 402 may use a second frequency band of 5 MHz among the 20 MHz frequency band, which is contiguous to the first frequency band, to perform the OFDMA based communications. Also, the third STA 403 may use a third frequency band of 10 MHz among the 20 MHz frequency band, which is contiguous to the second frequency band, to perform the OFDMA based communications. Here, the STA4 may operate in the second frequency band.

Hereinafter, a method, performed in a STA and an AP corresponding to the STA based on the WLAN topology explained referring to FIG. 4, will be explained. The WLAN topology in which exemplary embodiments of the present disclosure is not restricted to the WLAN topology explained referring to FIG. 4. That is, exemplary embodiments of the present disclosure can be performed in various WLAN topologies. Although a method (e.g., frame transmission or reception) performed by a first communication entity will be described below, a second communication entity that corresponds thereto may perform a method (e.g., frame reception or transmission) corresponding to the method performed by the first communication entity. In other words, when an operation of the non-AP STA is described, the AP STA corresponding thereto may be configured to perform an operation that corresponds to the operation of the non-AP STA. Additionally, when an operation of the AP STA is described, the non-AP STA may be configured to perform an operation that corresponds to the operation of the AP STA.

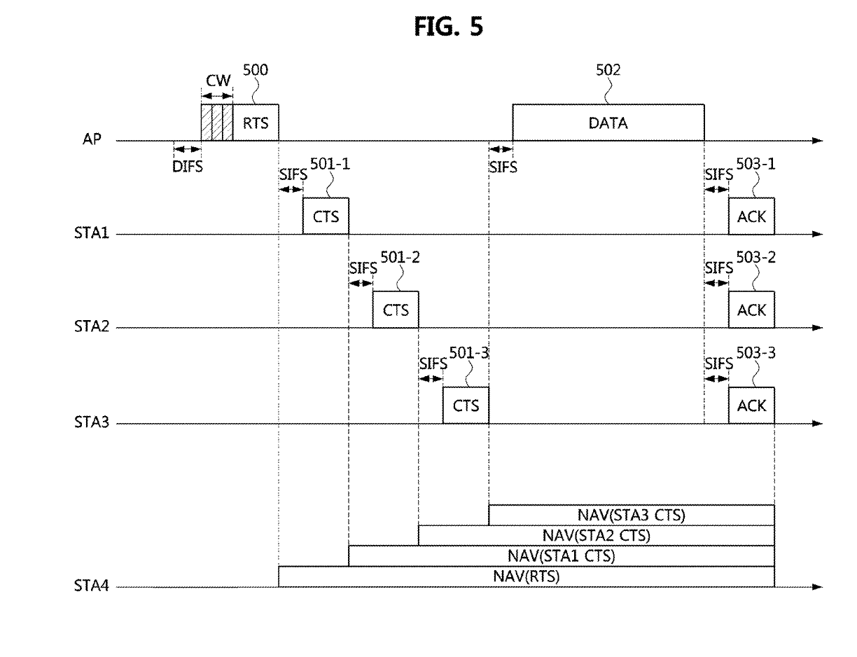

FIG. 5 is a timing diagram illustrating an OFDMA based downlink transmission method according to an exemplary embodiment of the present disclosure.

Referring to FIG. 5, the AP, the STA1, the STA2, the STA3, and the STA4 may be the AP 400, the first STA 401, the second STA 402, the third STA 403, and the fourth STA 404 which were explained referring to FIG. 4. The AP, the STA1, the STA2, and the STA3 may participate in OFDMA based communications.

The AP, which wants to transmit a data frame 502 in the OFDMA manner, may generate a RTS frame 500. The RTS frame 500 may comprise a MAC header and a payload. The RTS frame 500 may include at least one of an indicator configured to indicate that the OFDMA based communications are performed (e.g. indicating that a frequency band is used as divided), respective identifiers of a plurality of STAs (e.g. STA1, STA2, and STA3) participating in the OFDMA based communications, time resource information indicating a time resource to be occupied for the OFDMA based communications, frequency resource information indicating a frequency resource to be occupied for the OFDMA based communications, and per-STA time resource information indicating respective time resources occupied by data units for respective STAs (e.g. STA1, STA2, and STA3) included in the data frame 502.

The indicator configured to indicate that the OFDMA based communications are performed may be included in a MAC header or a payload of the RTS frame 500. For example, in a case that the indicator is set to a binary number ‘0’, the indicator may indicate that the OFDMA based communications are performed. On the contrary, in a case that the indicator is set to a binary number ‘1’, the indicator may indicate that other communications except OFDMA (e.g. OFDM based communications, etc.) are performed. Respective identifiers of the plurality of STAs (e.g. STA1, STA2, and STA3) participating in the OFDMA based communications may be included in the MAC header or the payload of the RTS frame 500. The identifier may be a MAC address, an association identifier (AID), or a partial AID of each of the plurality of stations STA1, STA2, and STA3.

The time resource information indicating a time resource to be occupied for the OFDMA based communications may be included in the MAC header or the payload of the RTS frame 500. For example, the time resource information may be included in a duration field of the MAC header. The time resource indicated by the time resource information may be configured as the longest time resource among time resources occupied by the respective plurality of stations (STA1, STA2, and STA3) participating in the OFDMA based communications. That is, lengths of data units for the respective plurality of stations (STA1, STA2, and STA3), which are included in the data frame 502, may be different from one another. In this case, in order to guarantee reception of data units at all the stations (STA1, STA2, and STA3), the time resource indicated by the time resource information may be configured as the longest time resource among the time resources occupied by the respective plurality of stations (STA1, STA2, and STA3).

The frequency resource information indicating a frequency resource to be occupied for the OFDMA based communications may be included in the MAC header or the payload of the RTS frame 500. The frequency resource information may indicate frequency bands occupied by the respective plurality of stations (STA1, STA2, and STA3) participating in the OFDMA based communication. For example, the frequency resource information may indicate that the STA1 uses a first frequency band with a 20 MHz bandwidth in a total bandwidth 80 MHz, the STA2 uses a second frequency band with a 20 MHz bandwidth contiguous to the first frequency band in the total bandwidth 80 MHz, and the STA3 uses a third frequency band with a 40 MHz bandwidth contiguous to the second frequency band in the total bandwidth 80 MHz.

The per-STA frequency resource information indicating a frequency resource occupied by a data unit for each of the plurality of stations (STA1, STA2, and STA3), which is included in the data frame 502, may be included in the MAC header or the payload of the RTS frame 500.

In a case that the channel is maintained as idle state during a DIFS, the access point (AP) may transmit the RTS frame 500 after a lapse of a content window (CW) according to a random backoff operation. The RTS frame 500 may be transmitted in multicast manner or broadcast manner. The RTS frame 500 may be transmitted through a whole bandwidth (e.g. 80 MHz) used for the OFDMA based communications. For example, the RTS frame 500 may be transmitted as duplicated in unit of 20 MHz.

Each of the plurality of stations STA1, STA2, and STA3 may receive the RTS frame 500. Also, according to the indicator included in the RTS frame 500, each of the stations STA1, STA2, and STA3 may identify that the OFDMA based communications are performed. Each of the stations STA1, STA2, and STA3 may determine that it participates in the OFDMA based communications when its identifier is included in the received RTS frame 500, and determine its transmission order of a CTS frame 501-1, 501-2, or 501-3 based on an order of its identifier in the RTS frame 500.

For example, when the identifiers are included in the RTS frame 500 in sequence of STA1, STA2, and STA3, the STA1 may determine to transmit the CTS frame 501-1 firstly among the plurality of stations STA1, STA2, and STA3 participating in the OFDMA based communications, the STA2 may determine to transmit the CTS frame 501-2 after the transmission of the CTS frame 501-1, and the STA3 may determine to transmit the CTS frame 501-3 after the transmission of the CTS frame 501-2.

Each of the plurality of stations STA1, STA2, and STA3 may identify its resource used for the OFDMA based communications based on the time resource information and frequency resource information included in the RTS frame 500. For example, each of the plurality of stations STA1, STA2, and STA3 may identify that the time resource corresponding to a duration of ‘SIFS+CTS frame 501-1+SIFS+CTS frame 501-2+SIFS+CTS frame 501-3+SIFS+data frame 502+SIFS+ACK frames 503-1, 503-2, and 503-3’, and a frequency band with a 80 MHz bandwidth are used for the OFDMA based communications. Also, each of the plurality of stations STA1, STA2, and STA3 may identify a time resource occupied by each data unit included in the data frame 502 based on the per-STA time resource information included in the RTS frame 500.

The STA1 may generate the CTS frame 501-1 as a response to the RTS frame 500. The CTS frame 501-1 may include at least one of an indicator configured to indicate that the OFDMA based communications are performed, time resource information indicating a time resource occupied for the OFDMA based communications, frequency resource information indicating a frequency resource occupied for the OFDMA based communications, and per-STA time resource information indicating a time resource occupied by the data unit of the STA1, which is included in the data frame 502. Each of the indicator, the time resource information, the frequency resource information, and the per-STA time resource information may be included in a MAC header or a payload of the CTS frame 501-1. Here, each of the indicator, the time resource information, the frequency resource information, and the per-STA time resource information may be configured based on the indicator, the time resource information, the frequency resource information, and the per-STA time resource information which are received as included in the RTS frame 500. The STA1 may transmit the CTS frame 501-1 after a lapse of a SIFS from a time when the reception of the RTS frame 500 ends. The CTS frame 501-1 may be transmitted through the whole bandwidth (e.g. 80 MHz) used for the OFDMA based communications. For example, the CTS frame 501-1 may be transmitted as duplicated in unit of 20 MHz bandwidth.

The STA2 may generate the CTS frame 501-2 as a response to the RTS frame 500. The CTS frame 501-2 may include at least one of an indicator configured to indicate that the OFDMA based communications are performed, time resource information indicating a time resource occupied for the OFDMA based communications, frequency resource information indicating a frequency resource occupied for the OFDMA based communications, and per-STA time resource information indicating a time resource occupied by the data unit of the STA2, which is included in the data frame 502. Each of the indicator, the time resource information, the frequency resource information, and the per-STA time resource information may be included in a MAC header or a payload of the CTS frame 501-2. Here, each of the indicator, the time resource information, the frequency resource information, and the per-STA time resource information may be configured based on the indicator, the time resource information, the frequency resource information, and the per-STA time resource information which are received as included in the RTS frame 500. The STA2 may transmit the CTS frame 501-2 after a lapse of a SIFS from a time when the transmission of the CTS frame 501-1 ends. The CTS frame 501-2 may be transmitted through the whole bandwidth (e.g. 80 MHz) used for the OFDMA based communications. For example, the CTS frame 501-2 may be transmitted as duplicated in unit of 20 MHz bandwidth.

The STA3 may generate the CTS frame 501-3 as a response to the RTS frame 500. The CTS frame 501-3 may include at least one of an indicator configured to indicate that the OFDMA based communications are performed, time resource information indicating a time resource occupied for the OFDMA based communications, frequency resource information indicating a frequency resource occupied for the OFDMA based communications, and per-STA time resource information indicating a time resource occupied by the data unit of the STA3 which is included in the data frame 502. Each of the indicator, the time resource information, the frequency resource information, and the per-STA time resource information may be included in a MAC header or a payload of the CTS frame 501-3. Here, each of the indicator, the time resource information, the frequency resource information, and the per-STA time resource information may be configured based on the indicator, the time resource information, the frequency resource information, and the per-STA time resource information which are received as included in the RTS frame 500. The STA3 may transmit the CTS frame 501-3 after a lapse of a SIFS from a time when the transmission of the CTS frame 501-2 ends. The CTS frame 501-3 may be transmitted through a whole bandwidth (e.g. 80 MHz) used for the OFDMA based communications. For example, the CTS frame 501-3 may be transmitted as duplicated in unit of 20 MHz bandwidth.

Meanwhile, the STA4 operating in the second frequency band may receive the RTS frame 500, the CTS frame 501-1, the CTS frame 501-2, and the CTS frame 501-3. Thus, the STA4 may configure a NAV timer corresponding to a duration of ‘SIFS+CTS frame 501-1+SIFS+CTS frame 501-2+SIFS+CTS frame 501-3+SIFS+data frame 502+SIFS+ACK frames 503-1, 503-2, and 503-3’, when the STA4 receives the RTS frame 500. Also, the STA4 may configure a NAV timer corresponding to a duration of ‘SIFS+CTS frame 501-2+SIFS+CTS frame 501-3+SIFS+data frame 502+SIFS+ACK frames 503-1, 503-2, and 503-3, when the STA4 receives the CTS frame 501-1. Also, the STA4 may configure a NAV timer corresponding to a duration of ‘SIFS+CTS frame 501-3+SIFS+data frame 502+SIFS+ACK frames 503-1, 503-2, and 503-3 when the STA4 receives the CTS frame 501-2, and configure a NAV timer corresponding to a duration of ‘SIFS+data frame 502+SIFS+ACK frames 503-1, 503-2, and 503-3 when the STA4 receives the CTS frame 501-3.

The AP may receive the CTS frames 501-1, 501-2, and 501-3, and transmit the data frame 502 to the plurality of stations STA1, STA2, and STA3 participating in the OFDMA based communications, after a lapse of a SIFS from a time when the CTS frame 501-3 ends. The data frame 502 may be transmitted in the OFDMA manner. The STA1 may receive its data unit included in the data frame 502 through the first frequency band having 20 MHz width, the STA2 may receive its data unit included in the data frame 502 through the second frequency band, having 20 MHz width, contiguous to the first frequency band, and the STA3 may receive its data unit included in the data frame 502 through the third frequency band having 40 MHz width, contiguous to the second frequency band.

When the data frame 502 is received successfully, the plurality of stations STA1, STA2, and STA3 may respectively transmit the ACK frames 503-1, 503-2, and 503-3 after a lapse of a SIFS from a time when the data frame 502 ends. The ACK frames 503-1, 503-2, and 503-3 may be transmitted in the OFDMA manner. For example, the STA1 may transmit the ACK frame 503-1 through the first frequency band having 20 MHz width, the STA2 may transmit the ACK frame 503-2 through the second frequency band having 20 MHz width contiguous to the first frequency band, and the STA3 may transmit the ACK frame 503-3 through the third frequency band having 40 MHz width contiguous to the second frequency band. Here, the ACK frame 503-3 may be transmitted as duplicated in unit of 20 MHz. Upon receiving the ACK frames 503-1, 503-2, and 503-3, the AP may determine that the data frame 502 has been successfully received at each of the stations STA1, STA2, and STA3. Meanwhile, the STA4 may attempt a channel access when the NAV timer expires. That is, the STA4 may attempt the channel access after the ACK frames 503-1, 503-2, and 503-3 end.

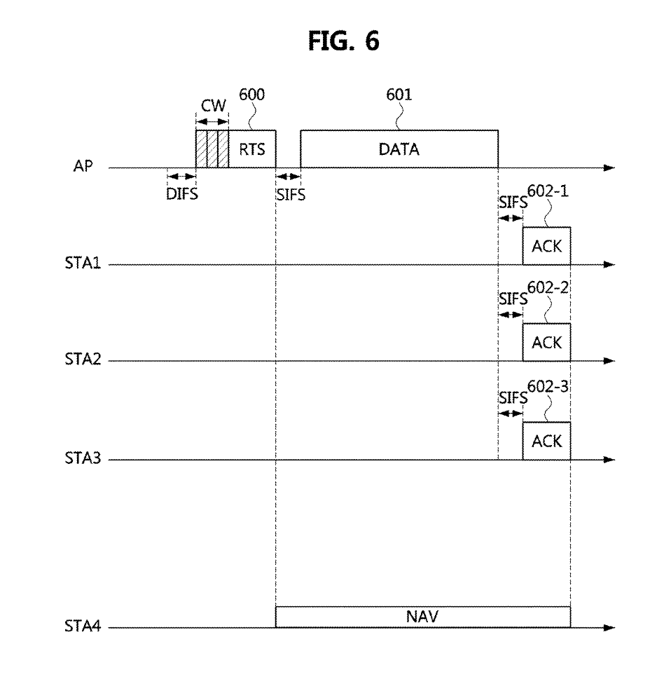

FIG. 6 is a timing diagram illustrating an OFDMA based downlink transmission method according to another exemplary embodiment of the present disclosure.

Referring to FIG. 6, the AP, the STA1, the STA2, the STA3, and the STA4 may be respectively the AP 400, the first station 401, the second station 402, the third station 403, and the fourth station 404 which were explained by referring to FIG. 4. Also, the AP, and the plurality of stations STA1, STA2, and STA3 may participate in the OFDMA based communications. The OFDMA based downlink transmission method illustrated in FIG. 6 may not include a procedure of transmitting and receiving CTS frames, differently from the OFDMA based downlink transmission method illustrated in FIG. 5.

The AP wanting to transmit a data frame 601 in the OFDMA manner may generated a RTS frame 600. The RTS frame 600 may comprise a MAC header and a payload. The RTS frame 600 may include at least one of an indicator indicating that the OFDMA based communications are performed (e.g. an indicator indicating that a frequency band is used as divided), respective identifiers of the plurality of stations STA1, STA2, and STA3 participating in the OFDMA based communications, time resource information indicating a time resource occupied for the OFDMA based communications, frequency resource information indicating a frequency resource occupied for the OFDMA based communications, and per-STA time resource information indicating a time resource occupied by a data unit of each of the plurality of stations STA1, STA2, and STA3, which is included in the data frame 601. The indicator, identifiers, time resource information, frequency resource information, and per-STA time resource information may be included in the MAC header or the payload of the RTS frame 600. Here, each of the indicator, identifiers, time resource information, frequency resource information, and per-STA time resource information may be identical to or similar with the indicator, identifiers, time resource information, frequency resource information, and per-STA time resource information which were explained by referring to FIG. 5.

In a case that a channel is maintained as an idle state during a DIFS, the AP may transmit the RTS frame 600 after a lapse of a CW according to a random backoff operation. The RTS frame 600 may be transmitted in multicast manner or broadcast manner. The RTS frame 600 may be transmitted through a whole frequency band (e.g. 80 MHz) used for the OFDMA based communications. For example, the RTS frame 600 may be transmitted as duplicated in unit of 20 MHz.

Each of the plurality of stations STA1, STA2, and STA3 may receive the RTS frame 600. Based on the indicator included in the RTS frame 600, each of the plurality of stations STA1, STA2, and STA3 may identify that the OFDMA based communication are performed. Also, each of the plurality of stations STA1, STA2, and STA3 may determine that it participates in the OFDMA based communication, when its identifier is included in the RTS frame 600.

Each of the plurality of stations STA1, STA2, and STA3 may identify resources used for the OFDMA based communications based on the time resource information and the frequency resource information which are included in the RTS frame 600. For example, each of STA1, STA2, and STA3 may determine that a time resource corresponding to a duration of ‘SIFS+data frame 601+SIFS+ACK frames 602-1, 602-2, and 602-3’ is used for the OFDMA based communications, and that a frequency band of 80 MHz is used for the OFDMA based communications. Also, each of STA1, STA2, and STA3 may identify a time resource occupied by its data unit included in the data frame 601 based on the per-STA time resource information included in the RTS frame 600. On the other hand, the STA4 operating in a second frequency band also may receive the RTS frame 600, and configure a NAV timer corresponding to a duration of ‘SIFS+data frame 601+SIFS+ACK frames 602-1, 602-2, and 602-3’.

The AP may transmit the data frame 601 to the plurality of stations STA1, STA2, and STA3 participating in the OFDMA based communications after a lapse of a SIFS after from a time when the RTS frame 600 ends. The data frame 601 may be transmitted in the OFDMA manner. The STA1 may receive a data unit included in the data frame 601 through a first frequency band of 20 MHz, the STA2 may receive a data unit included in the data frame 601 through a second frequency band of 20 MHz which is contiguous to the first frequency band, and the STA3 may receive a data unit included in the data frame 601 through a third frequency band of 40 MHz which is contiguous to the second frequency band.

Upon successfully receiving the data frame 601, each of the plurality of stations STA1, STA2, and STA3 may transmit each of ACK frames 602-1, 602-2, and 602-3 after a lapse of a SIFS from a time when the data frame 601 ends. The ACK frames 602-1, 602-2, and 602-3 may be transmitted in OFDMA manner. For example, the STA1 may transmit the ACK frame 602-1 through the first frequency band of 20 MHz, the STA2 may transmit the ACK frame 602-2 through the second frequency band of 20 MHz contiguous to the first frequency band, and the STA3 may transmit the ACK frame 602-3 through the third frequency band of 40 MHz contiguous to the second frequency band. Here, the ACK frame 602-3 may be transmitted as duplicated in unit of 20 MHz. When each of the ACK frames 602-1, 602-2, and 602-3 is received successfully at the AP, the AP may determine that the data frame 601 has been successfully received by each of the STA1, STA2, and STA3. Meanwhile, the STA4 may attempt a channel access after the NAV timer expires. That is, the STA4 may attempt a channel access after the ACK frames 602-1, 602-2, and 602-3 end.

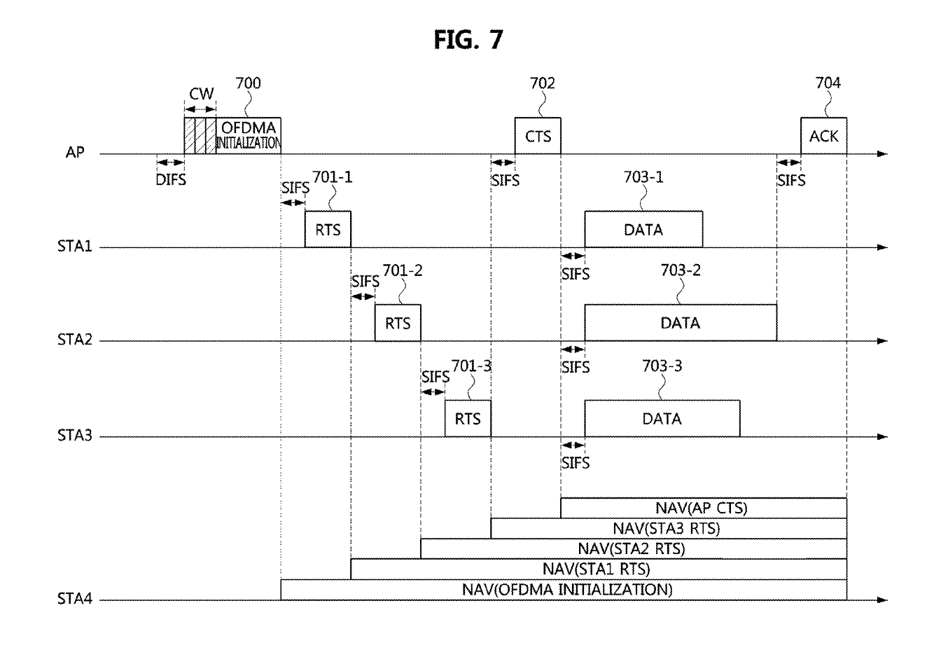

FIG. 7 is a timing diagram illustrating an OFDMA based uplink transmission method according to an exemplary embodiment of the present disclosure.

Referring to FIG. 7, the AP, the STA1, the STA2, the STA3, and the STA4 may be respectively the AP 400, the first station 401, the second station 402, the third station 403, and the fourth station 404 which were explained by referring to FIG. 4. Also, the AP, and the plurality of stations STA1, STA2, and STA3 may participate in the OFDMA based communications.

The AP may generate an OFDMA initialization frame 700 instructing an initiation of an OFDMA based communication. The OFDMA initialization frame 700 may be a management frame, a control frame, or a data frame. The OFDMA initialization frame 700 may comprise a MAC header and a payload. The OFDMA initialization frame may include at least one of an indicator indicating that the OFDMA based communications are performed (e.g. an indicator indicating that a frequency band is used as divided), respective identifiers of the plurality of stations STA1, STA2, and STA3 participating in the OFDMA based communications, time resource information indicating a time resource occupied for the OFDMA based communications, frequency resource information indicating a frequency resource occupied for the OFDMA based communications, and per-STA time resource information indicating a time resource occupied by each of data frames 703-1, 703-2, and 703-3 for the plurality of stations STA1, STA2, and STA3.

The indicator indicating that the OFDMA based communications are performed may be included in a MAC header or a payload of the OFDMA initialization frame 700. For example, the indicator configured as a binary number ‘0’ may indicate that the OFDMA based communications are performed. On the contrary, the indicator configured as a binary number ‘1’ may indicate that other type communications (e.g. OFDM based communications, etc.) except the OFDMA based communications are performed. Respective identifiers of the plurality of stations STA1, STA2, and STA3 participating in the OFDMA based communication may be included in the MAC header or the payload of the OFDMA initialization frame 700. Each of the identifiers may be a MAC address, an AID, or a PAID of each of the plurality of stations STA1, STA2, and STA3.

The time resource information indicating the time resource occupied for the OFDMA based communications may be included in the MAC header or the payload of the OFDMA initialization frame 700. For example, the time resource information may be included in a duration field of the MAC header. The time resource indicated by the time resource information may be configured as the longest time resource among time resources occupied by the plurality of stations STA1, STA2, and STA3 participating in the OFDMA based communications. That is, the lengths of the data frames 703-1, 703-2, and 703-3 for the respective plurality of stations may be different from one another. In this case, in order to guarantee reception of all data frames 703-1, 703-2, and 703-3, the AP may configure the longest time resource among the time resources occupied by the plurality of stations STA1, STA2, and STA3, as the time resource indicated by the time resource information.

The frequency resource information indicating the frequency resource occupied for the OFDMA based communications also may be included in the MAC header or the payload of the OFDMA initialization frame 700. The frequency resource information may indicate frequency bands occupied by respective stations of the plurality of stations STA1, STA2, and STA3 participating in the OFDMA based communications. For example, the frequency resource information may indicate that the STA1 uses a first frequency band of 20 MHz from a total 80 MHz bandwidth, the STA2 uses a second frequency band of 20 MHz contiguous to the first frequency band from the total 80 MHz bandwidth, and the STA3 uses a third frequency band of 40 MHz contiguous to the second frequency band from the total 80 MHz bandwidth. The per-STA time resource information indicating time resources occupied by data frames 703-1, 703-2, and 703-3 for the respective plurality of stations STA1, STA2, and STA3 may also be included in the MAC header or the payload of the OFDMA initialization frame 700.

In a case that a channel is maintained as idle state during a DIFS, the AP may transmit the OFDMA initialization frame 700 after a lapse of a CW according to a random backoff operation. The OFDMA initialization frame 700 may be transmitted in multicast manner or broadcast manner. The OFDMA initialization frame 700 may be transmitted through the whole frequency band (e.g. 80 MHz) used for the OFDMA based communications. For example, the OFDMA initialization frame 700 may be transmitted as duplicated in unit of 20 MHz.

Each of the plurality of stations STA1, STA2, and STA3 may receive the OFDMA initialization frame 700. Based on the indicator included in the OFDMA initialization frame 700, each of the plurality of stations STA1, STA2, and STA3 may identify that the OFDMA based communication are performed. Also, each of the plurality of stations STA1, STA2, and STA3 may determine that it participates in the OFDMA based communication, when its identifier is included in the OFDMA initialization frame 700, and determine its sequence of transmitting a RTS frame 701-1, 701-2, or 701-3 based on a sequence of its identifier in the OFDMA initialization frame 700.

For example, when the identifiers are included in the OFDMA initialization frame 700 in sequence of STA1, STA2, and STA3, the STA1 may determine to transmit the RTS frame 701-1 firstly among the plurality of stations STA1, STA2, and STA3 participating in the OFDMA based communications, the STA2 may determine to transmit the RTS frame 701-2 after the transmission of the RTS frame 701-1, and the STA3 may determine to transmit the RTS frame 701-3 after the transmission of the RTS frame 701-2.

Each of the plurality of stations STA1, STA2, and STA3 may identify its resource used for the OFDMA based communications based on the time resource information and frequency resource information included in the OFDMA initialization frame 700. For example, each of the plurality of stations STA1, STA2, and STA3 may identify that the time resource corresponding to a duration of ‘SIFS+RTS frame 701-1+SIFS+RTS frame 701-2+SIFS+RTS frame 701-3+SIFS+CTS frame 702+SIFS+data frame 703-2+SIFS+ACK frame 704’ and a frequency band with a 80 MHz bandwidth are used for the OFDMA based communications. Also, each of the plurality of stations STA1, STA2, and STA3 may identify a time resource occupied by each of data frames 704-1, 704-2, or 704-3 based on the per-STA time resource information included in the OFDMA initialization frame 700.

The STA1 may generate the RTS frame 701-1. The RTS frame 701-1 may include at least one of an indicator configured to indicate that the OFDMA based communications are performed, time resource information indicating a time resource occupied for the OFDMA based communications, frequency resource information indicating a frequency resource occupied for the OFDMA based communications, and per-STA time resource information indicating a time resource occupied by the data frame 703-1. Each of the indicator, the time resource information, the frequency resource information, and the per-STA time resource information may be included in a MAC header or a payload of the RTS frame 701-1. Here, each of the indicator, the time resource information, the frequency resource information, and the per-STA time resource information may be configured based on the indicator, the time resource information, the frequency resource information, and the per-STA time resource information which are received as included in the OFDMA initialization frame 700. The STA1 may transmit the RTS frame 701-1 after a lapse of a SIFS from a time when the reception of the OFDMA initialization frame 700 ends. The RTS frame 701-1 may be transmitted through the whole bandwidth (e.g. 80 MHz) used for the OFDMA based communications. For example, the RTS frame 701-1 may be transmitted as duplicated in unit of 20 MHz bandwidth.

The STA2 may generate the RTS frame 701-2. The RTS frame 701-2 may include at least one of an indicator configured to indicate that the OFDMA based communications are performed, time resource information indicating a time resource occupied for the OFDMA based communications, frequency resource information indicating a frequency resource occupied for the OFDMA based communications, and per-STA time resource information indicating a time resource occupied by the data frame 703-2. Each of the indicator, the time resource information, the frequency resource information, and the per-STA time resource information may be included in a MAC header or a payload of the RTS frame 701-2. Here, each of the indicator, the time resource information, the frequency resource information, and the per-STA time resource information may be configured based on the indicator, the time resource information, the frequency resource information, and the per-STA time resource information which are received as included in the OFDMA initialization frame 700. The STA2 may transmit the RTS frame 701-2 after a lapse of a SIFS from a time when the transmission of the RTS frame 701-1 ends. The RTS frame 701-2 may be transmitted through the whole bandwidth (e.g. 80 MHz) used for the OFDMA based communications. For example, the RTS frame 701-2 may be transmitted as duplicated in unit of 20 MHz bandwidth.

The STA3 may generate the RTS frame 701-3. The RTS frame 701-3 may include at least one of an indicator configured to indicate that the OFDMA based communications are performed, time resource information indicating a time resource occupied for the OFDMA based communications, frequency resource information indicating a frequency resource occupied for the OFDMA based communications, and per-STA time resource information indicating a time resource occupied by the data frame 703-3. Each of the indicator, the time resource information, the frequency resource information, and the per-STA time resource information may be included in a MAC header or a payload of the RTS frame 701-3. Here, each of the indicator, the time resource information, the frequency resource information, and the per-STA time resource information may be configured based on the indicator, the time resource information, the frequency resource information, and the per-STA time resource information which are received as included in the OFDMA initialization frame 700. The STA3 may transmit the RTS frame 701-3 after a lapse of a SIFS from a time when the transmission of the RTS frame 701-2 ends. The RTS frame 701-3 may be transmitted through the whole bandwidth (e.g. 80 MHz) used for the OFDMA based communications. For example, the RTS frame 701-3 may be transmitted as duplicated in unit of 20 MHz bandwidth.

The AP may receive each of the RTS frames 701-1, 701-2, and 701-3, and generate a CTS frame 702 as a response to the RTS frames 701-1, 701-2, and 701-3. The CTS frame 702 may include at least one of an indicator configured to indicate that the OFDMA based communications are performed, time resource information indicating a time resource occupied for the OFDMA based communications, frequency resource information indicating a frequency resource occupied for the OFDMA based communications, and per-STA time resource information indicating respective time resources occupied by the data frames 703-1, 703-2, and 703-3. Each of the indicator, the time resource information, the frequency resource information, and the per-STA time resource information may be included in a MAC header or a payload of the CTS frame 702. Here, each of the indicator, the time resource information, the frequency resource information, and the per-STA time resource information may be configured based on the indicator, the time resource information, the frequency resource information, and the per-STA time resource information which are received as included in the OFDMA initialization frame 700.

The AP may transmit the CTS frame 702 after a lapse of a SIFS from a time when the RTS frame 701-3 ends. The CTS frame 702 may be transmitted through the whole frequency band (e.g. 80 MHz) used for the OFDMA based communications. For example, the CTS frame 702 may be transmitted as duplicated in unit of 20 MHz. Alternatively, the CTS frame 702 may be transmitted in the OFDMA manner. For example, the AP may transmit the CTS frame 702 for the STA1 through a first frequency band of 20 MHz, the CTS frame 702 for the STA2 through a second frequency band of 20 MHz contiguous to the first frequency band, and the CTS frame 702 for the STA3 through a third frequency band of 40 MHz contiguous to the second frequency band. Here, the CTS frame 702 transmitted through the third frequency band may be duplicated in unit of 20 MHz.

Meanwhile, the STA4 operating on the second frequency band also may receive the OFDMA initialization frame 700, the RTS frames 701-1, 701-2, and 701-3, and the CTS frame 702. Thus, the STA4 may configure a NAV timer corresponding to a duration of ‘SIFS+RTS frame 701-1+SIFS+RTS frame 701-2+SIFS+RTS frame 701-3+SIFS+CTS frame 702+SIFS+data frame 703-2+SIFS+ACK frame 704’ when the STA4 receive the OFDMA initialization frame 700, configure a NAV timer corresponding to a duration of ‘SIFS+RTS frame 701-2+SIFS+RTS frame 701-3+SIFS+CTS frame 702+SIFS+data frame 703-2+SIFS+ACK frame 704’ when the STA4 receive the RTS frame 701-1, configure a NAV timer corresponding to a duration of ‘SIFS+RTS frame 701-3+SIFS+CTS frame 702+SIFS+data frame 703-2+SIFS+ACK frame 704’ when the STA4 receives the RTS frame 701-2, configure a NAV timer corresponding to a duration of ‘SIFS+CTS frame 702+SIFS+data frame 703-2+SIFS+ACK frame 704’ when the STA4 receives the RYS frame 701-3, and configure a NAV timer corresponding to a duration of ‘SIFS+data frame 703-2+SIFS+ACK frame 704’ when the STA4 receives the CTS frame 702.

Each of the plurality of stations STA1, STA2, and STA3 may generate its data frame 703-1, 703-2, or 703-3 having a length corresponding to the time resource indicated by its per-STA time resource information. Alternatively, each of the plurality of stations STA1, STA2, and STA3 may generate its data frame 703-1, 703-2, or 703-3 having a length corresponding to the length of the longest data frame among the data frames 703-1, 703-2 and 703-3. The STA1 may transmit the data frame 703-1 to the AP through the first frequency band of 20 MHz. The STA2 may transmit the data frame 703-2 to the AP through the second frequency band of 20 MHz contiguous to the first frequency band. The STA3 may transmit the data frame 703-3 to the AP through the third frequency band of 40 MHz contiguous to the second frequency band. That is, the data frames 703-1, 703-2, and 703-3 may be transmitted in the OFDMA manner.

The AP may receive the data frames 703-1, 703-2, and 703-3 from the plurality of stations STA1, STA2, and STA3. Upon successfully receiving the data frames 703-1, 703-2, and 703-3, the AP may transmit the ACK frame 704 to each of the STA1, STA2, and STA3 after a lapse of a SIFS from a time when the longest data frame (e.g. the data frame 703-2) among the data frames ends.

The ACK frame 704 may be transmitted in the OFDMA manner. The AP may transmit the ACK frame 704 for the STA1 through the first frequency band of 20 MHz, the ACK frame 704 for the STA2 through the second frequency band of 20 MHz contiguous to the first frequency band, and the ACK frame 704 for the STA3 through the third frequency band of 40 MHz contiguous to the second frequency band. Here, the ACK frame 704 for the STA3 may be transmitted as duplicated in unit of 20 MHz. Meanwhile, the STA4 may attempt a channel access after the NAV timer expires. That is, the STA4 may attempt a channel access after the ACK frame 704 ends.

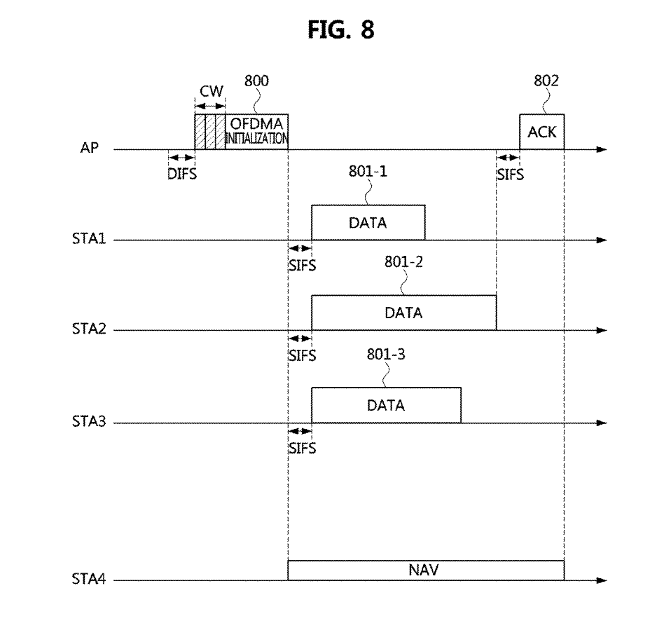

FIG. 8 is a timing diagram illustrating an OFDMA based uplink transmission method according to another exemplary embodiment of the present invention.

Referring to FIG. 8, the AP, the STA1, the STA2, the STA3, and the STA4 may be respectively the AP 400, the first station 401, the second station 402, the third station 403, and the fourth station 404 which were explained by referring to FIG. 4. Also, the AP, and the plurality of stations STA1, STA2, and STA3 may participate in the OFDMA based communications. The OFDMA based uplink transmission method illustrated in FIG. 8 may not include a procedure of transmitting and receiving a RTS frame and a CTS frame, differently from the OFDMA based uplink transmission method illustrated in FIG. 7.

The AP may generate an OFDMA initialization frame 800 instructing an initiation of an OFDMA based communication. The OFDMA initialization frame 800 may be a management frame, a control frame, or a data frame. The OFDMA initialization frame 800 may comprise a MAC header and a payload. The OFDMA initialization frame 800 may include at least one of an indicator indicating that the OFDMA based communications are performed (e.g. an indicator indicating that a frequency band is used as divided), respective identifiers of the plurality of stations STA1, STA2, and STA3 participating in the OFDMA based communications, time resource information indicating a time resource occupied for the OFDMA based communications, frequency resource information indicating a frequency resource occupied for the OFDMA based communications, and per-STA time resource information indicating a time resource occupied by each of data frames 801-1, 801-2, and 801-3 for the plurality of stations STA1, STA2, and STA3. The indicator, identifiers, time resource information, frequency resource information, and per-STA time resource information may be included in the MAC header or the payload of the OFDMA initialization frame 800. Here, each of the indicator, identifiers, time resource information, frequency resource information, and per-STA time resource information may be identical to or similar with the indicator, identifiers, time resource information, frequency resource information, and per-STA time resource information which were explained by referring to FIG. 7.

In a case that a channel is maintained as idle state during a DIFS, the AP may transmit the OFDMA initialization frame 800 after a lapse of a CW according to a random backoff operation. The OFDMA initialization frame 800 may be transmitted in multicast manner or broadcast manner. The OFDMA initialization frame 800 may be transmitted through the whole frequency band (e.g. 80 MHz) used for the OFDMA based communications. For example, the OFDMA initialization frame 800 may be transmitted as duplicated in unit of 20 MHz.

Each of the plurality of stations STA1, STA2, and STA3 may receive the OFDMA initialization frame 800. Based on the indicator included in the OFDMA initialization frame 800, each of the plurality of stations STA1, STA2, and STA3 may identify that the OFDMA based communication are performed. Also, each of the plurality of stations STA1, STA2, and STA3 may determine that it participates in the OFDMA based communication, when its identifier is included in the OFDMA initialization frame 800.

Each of the plurality of stations STA1, STA2, and STA3 may identify resources used for the OFDMA based communications based on the time resource information and the frequency resource information which are included in the OFDMA initialization frame 800. For example, each of STA1, STA2, and STA3 may determine that a time resource corresponding to a duration of ‘SIFS+data frame 801-2+SIFS+ACK frame 802’ is used for the OFDMA based communications, and that a frequency band of 80 MHz is used for the OFDMA based communications. Also, each of STA1, STA2, and STA3 may identify a time resource occupied by its data frame 801-1, 801-2, or 801-3 based on the per-STA time resource information included in the OFDMA initialization frame 800.

On the other hand, the STA4 operating on a second frequency band also may receive the OFDMA initialization frame 800, and configure a NAV timer corresponding to a duration of ‘SIFS+data frame 801-2+SIFS+ACK frame 802’.

Each of the plurality of stations STA1, STA2, and STA3 may generate its data frame 801-1, 801-2, or 801-3 having a length corresponding to the time resource indicated by its per-STA time resource information. Alternatively, each of the plurality of stations STA1, STA2, and STA3 may generate its data frame 801-1, 801-2, or 801-3 having a length corresponding to the length of the longest data frame among the data frames 801-1, 801-2 and 801-3. The STA1 may transmit the data frame 801-1 to the AP through a first frequency band of 20 MHz. The STA2 may transmit the data frame 801-2 to the AP through a second frequency band of 20 MHz contiguous to the first frequency band. The STA3 may transmit the data frame 801-3 to the AP through a third frequency band of 40 MHz contiguous to the second frequency band. That is, the data frames 801-1, 801-2, and 801-3 may be transmitted in the OFDMA manner.

The AP may receive the data frames 801-1, 801-2, and 801-3 from the plurality of stations STA1, STA2, and STA3. Upon successfully receiving the data frames 801-1, 801-2, and 801-3, the AP may transmit the ACK frame 802 to each of the STA1, STA2, and STA3 a SIFS after the longest data frame (e.g. the data frame 801-2) among the data frames ends. The ACK frame 802 may be transmitted in the OFDMA manner. The AP may transmit the ACK frame 802 for the STA1 through the first frequency band of 20 MHz, the ACK frame 802 for the STA2 through the second frequency band of 20 MHz contiguous to the first frequency band, and the ACK frame 802 for the STA3 through the third frequency band of 40 MHz contiguous to the second frequency band. Here, the ACK frame 802 for the STA3 may be transmitted as duplicated in unit of 20 MHz. Meanwhile, the STA4 may attempt a channel access after the NAV timer expires. That is, the STA4 may attempt a channel access after the ACK frame 802 ends.

Exemplary embodiments of the inventive concept may be recorded in a computer-readable record medium by being implemented in the form of program instructions which are executable using various computer components. The computer-readable record medium may include program instructions, data files, data structures, etc., alone or in combination. The program instructions recorded in the computer-readable record medium may be specially designed for the inventive concept, or may be known to those skilled in the art of the computer software field.

Examples of the computer-readable record medium may include a hardware device, which is specially configured to store and execute the program instructions, such as a floptical disk, a read only memory (ROM), a random access memory (RAM), a flash memory, etc. The hardware device may be configured to operate as one or more software modules to perform the method according to exemplary embodiments of the inventive concept, and vice versa. Examples of the program instructions may include mechanical codes which are made by a compiler, and high-level language codes which are executable by a computer using an interpreter, etc.

While the example embodiments of the present disclosure and their advantages have been described in detail, it should be understood that various changes, substitutions and alterations may be made herein without departing from the scope of the disclosure.

1. A method for orthogonal frequency division multiple access (OFDMA) based communications, performed by a first station, the method comprising:
receiving a first frame including time resource information and frequency resource information indicating a resource occupied for the OFDMA based communications from an access point (AP); and
receiving a data frame from the AP through the resource indicated by the time resource information and the frequency resource information.

2. The method according to claim 1, wherein the first frame is a Request-To-Send (RTS) frame.

3. The method according to claim 1, wherein the first frame includes an indicator which indicates that the OFDMA based communications are performed.

4. The method according to claim 1, wherein the first frame includes identifiers for a plurality of stations participating in the OFDMA based communications.

5. The method according to claim 1, wherein the first frame includes information on a time resource occupied by a data unit included in a data frame, which each of the plurality of stations participating in the OFDMA based communications receives.

6. The method according to claim 1, wherein the first frame is received through a whole bandwidth of a frequency resource indicated by the frequency resource information.

7. The method according to claim 1, wherein the frequency resource information is included in a payload of the first frame.

8. The method according to claim 1, wherein a longest time resource among time resources occupied by the plurality of stations participating in the OFDMA based communications is configured as a time resource indicated by the time resource information.

9. The method according to claim 1, further comprising:
in response to the first frame, transmitting a second frame including the time resource information and the frequency resource information to the AP.

10. The method according to claim 9, wherein the second frame is a Clear-To-Send (CTS) frame.

11. A method for orthogonal frequency division multiple access (OFDMA) based communications, performed by a first station, the method comprising:
receiving a first frame including time resource information and frequency resource information indicating a resource occupied for the OFDMA communications from an access point (AP); and
transmitting a data frame to the AP through the resource indicated by the time resource information and the frequency resource information.

12. The method according to claim 11, wherein the first frame includes an indicator which indicates that the OFDMA based communications are performed.

13. The method according to claim 11, wherein the first frame includes identifiers for a plurality of stations participating in the OFDMA based communications.

14. The method according to claim 11, wherein the first frame includes information on a time resource occupied by a data unit included in a data frame, which each of the plurality of stations participating in the OFDMA based communications receives.

15. The method according to claim 11, wherein a longest time resource among time resources occupied by the plurality of stations participating in the OFDMA based communications is configured as a time resource indicated by the time resource information.

16. The method according to claim 11, further comprising:
when the first frame is received, transmitting a second frame including the time resource information and the frequency resource information; and
receiving, as a response to the second frame, a third frame including the time resource information and the frequency resource information from the AP.

17. The method according to claim 16, wherein the second frame is a Request-To-Send (RTS) frame.

18. The method according to claim 16, wherein the second frame is transmitted through a whole bandwidth of a frequency resource indicated by the frequency resource information.

19. The method according to claim 16, wherein the frequency resource information is included in a payload of the second frame.

20. The method according to claim 16, wherein the third frame is a Clear-To-Send (CTS) frame.
